(19) United States
(12) Patent Application Publication
(10) Pub. No.: US 2007/0277829 A1
(43) Pub. Date: Dec. 6, 2007

(54) Face mask

(76) Inventor: Malcolm Casewell, Wokingham (GB)

Correspondence Address: Kathleen R. Terry, #314, 1666 Coffman Street, Falcon Heights, MN, 55108, US

(21) Appl. No.: 11/446,617

(22) Filed: Jun. 5, 2006

(51) Int. Cl. A62B 18/00

(52) U.S. Cl. 128/206.24

(57) ABSTRACT

A combined half mask respirator and eye protector is provided, portions of the mask above the respirator being open to provide air circulation behind a lens and reduce misting of the lens. A face seal for the respirator of elastomeric material inhibits air leakage from the respirator to behind the lens, and outlet from the respirator is controlled by a flap valve which offers minimal flow resistance, also for preventing development of overpressure in the respirator and leakage of air to behind the lens.

### FIELD OF THE INVENTION

The present invention relates to a face mask particularly, but not exclusively, for model makers, wood-workers, and those engaged in do-it-yourself household maintenance.

### BACKGROUND TO THE INVENTION

Inexpensive disposable moulded or thermoformed face masks that cover the nose and mouth are conventionally constructed of layers of fibrous sheet material and have found numerous applications in dirty or dusty environments, particularly in industry and for those who are engaged in model making or do-it-yourself tasks. They have also found use in areas of medicine such as surgical masks. These masks are held on the face by one or more elastic bands or straps attached mechanically (such as by stapling), or by thermal fusing to the sides of the face mask to hold the mask to the face and to accomplish sealing of the mask over the nose and mouth. A mask of this type should completely seal around the nose and mouth and allows no air to pass between the mask and the face. Such masks are shown, for example, in U.S. Pat. No. 4,641,645 (Tayebi) Too often, however, due to the softness and flexibility of fibrous sheet materials from which masks are moulded, complete sealing around the bridge of the nose and mouth is not achieved.

Model makers and do-it-yourself enthusiasts work with mainly wood and plastic using various manufacturing methods. Many activities in industry, involve substances against which people need protection. Very fine aerosols or respirable dusts may be released by grinding, drilling and milling, as well as by painting and cleaning processes. Respirators are commonly used to protect against health issues that may be caused by release of such particles. Respirators may be classified according to which of two key types of contaminant they provide protection:

Particulates—most commonly used to protect against dusts. However anti-particulate respirators are also used to guard against fumes and mists created through mechanical processes such as sanding, welding or spray painting that introduce fine particles into the air.

Gases and vapors—This equipment protects against gaseous contaminants that can range from noxious acidic gases, including sulfur dioxide and alkaline gases such as ammonia, to less perceptible gases that displace oxygen and create hazards of hypoxia and, eventually, asphyxiation.

The most commonly used protective equipment by model makers is active against particulates. Wood dust cause a health risk due to allergic reactions and can affect the lungs, and also the eyes and skin. Exposure to some woods can cause extrinsic allergic alveolitis—a disease with “flu-like” symptoms, which can cause progressive lung damage. Exposure to wood dust can cause rhinitis (runny nose), violent sneezing, blocked nose, nosebleeds, and, very rarely, nasal cancer. The most common effects arise from irritation. In eyes the effects can include soreness, watering and conjunctivitis.

Half face and full face respirator masks are also known. For example, U.S. Pat. No. 5,924,420 (Reischel, et al., Minnesota Mining and Manufacturing) is concerned with the problem of increasing visibility for users of full-face respirator masks. The proposed solution is to provide a full face respirator mask that comprises:

(a) a rigid plastic lens that has a transparent viewing portion and a port portion, the port portion being disposed beneath the viewing portion when the mask is viewed from a front elevation;

(b) an exhalation port disposed in the port portion of the rigid plastic lens;

(c) first and second air intake ports disposed in the port portion of the rigid plastic lens on opposing sides of the exhalation port;

(d) first and second connectors that are integral with the rigid plastic lens in its port portion, the first and second connectors being configured for receiving first and second filter cartridges and being located on the port portion to allow intake air to be directed to the first and second intake ports, respectively; and (e) a face seal disposed on the full face respirator mask to seal the respirator over the wearer's eyes, nose, and mouth.

Providing a sealed respirator and glasses combined in an open mask, so protecting the areas listed above would be beneficial for such a ‘central’ user group with moderate exposure. The mask would prevent the dust from affecting the face and eyes, through the lens. The respirator would protect the nose and lungs, as they are sealed. However, it has been realized that there are drawbacks in a fully sealed respirator. Heat build-up and breathing resistance are two of the principal reasons why people refuse to wear respirators. To overcome these difficulties, many masks are equipped with an exhalation valve that reduces breathing resistance and heat build-up. when the user is breathing in.

Integrated eye protectors and respirators can leak exhaled air into the region of the eye protection and steam up the insides of the lens. This restricts vision and has implications for working especially with machinery and sharp tools.

### SUMMARY OF THE INVENTION

It is an object of the invention to provide a face mask that can provide users in a middle category of exposure, including many model makers and do-it-yourself enthusiasts, with both eye protection against flying objects and respiratory protection and which in use does not suffer from undue misting even when the user is engaged in manual work.

In the present invention these requirements have been substantially addressed by providing a face mask comprising a half mask negative pressure respirator that fits around the nose and mouth and a lens supported above the respirator for providing eye protection, portions of the mask carrying the lens being open to the surrounding air.

The present invention relates to a mask that is a combination of a half face negative pressure respirator and impact resistant safety lenses. Embodiments of the mask are also designed to fit comfortably around a standard pair of ear defenders, to protect the user from dust both being inhaled and from irritating the eyes, from flying objects hitting the eyes and face, from the steaming up of the inside of the lenses.

The mask has been designed to be durable and with all parts removable and replaceable. If a lens or seal is damaged or has worn out, a replacement part can easily be substituted. There are many parts to the mask to enable it to function fully. This also enables the user to dismantle the mask fully for general cleaning and maintenance.

Embodiments of the present mask are designed to overcome the problems of using a respirator, safety glasses and ear defenders together. There are a number of problems with equipment currently available. With separate glasses or goggles, the nose area of the respirator and the glasses interfere with the fitting of each other. The glasses or goggles tend to rise up on the respirator and not sit correctly on the face. A second problem is the arms of the glasses interfering with the ear defenders. The ear defenders have a strong grip and they push the arms of the glasses into the head of the wearer making the wearing of them uncomfortable

In detail, the invention is a face mask comprising a generally sheet-like plastics body configured to fit to the face of the user so as to extend between the forehead and the chin and from side regions of the forehead down the sides of the face to either side of the chin. A lens for providing eye protection is supported by the upper portions, which are open to the surrounding air. A half mask respirator is located at portions of the body below the lens and fits gas-tightly around the nose and mouth. Rearwardly facing walls on a normally concealed surface of the body define an outline of a breathing circuit area of the body and form part of the respirator and form a face seal that is a push fit onto the walls.

The body may be molded or otherwise formed from any suitable plastic material. Preferably the material is a mineral-filled plastic such as glass fibers embedded in nylon or mineral-filled polypropylene. A forehead pad attached to the under surface of the body above the lens provides a comfortable fit. The rearwardly facing lower lateral walls defined by portions of the body of the mask are formed with inlets opening into the breathing circuit area, and the walls are configured to support filter cartridges removably located to opposed sides of the mask. Filter cartridges suitable to remove noxious gases from the breathed air are well known in the art. The most common commercial filter is comprised of activated charcoal. However, special filters to suit the required needs may also be located on the opposed sides of the mask. An exhaust is located approximately in the middle of the breathing circuit area. An unidirectional flap valve controls flow of air through the exhaust.

The face seal of the mask is of elastomeric material and is formed with a groove on its forward face for fitting onto the rearwardly facing walls of the body defining the outline of the breathing circuit area. A preferred elastomeric material is silicone rubber. The face seal is made slightly undersized for fitting in tension onto the rearwardly facing walls.

### BRIEF DESCRIPTION OF THE DRAWINGS

How the invention may be put into effect will now be described, by way of example only, with reference to the accompanying drawings, in which:

FIG. 1 is a view from the front and obliquely below showing a face mask according to the invention;

FIG. 2 is a view of the mask of FIG. 1 from the rear and offset to the side;

FIG. 3 is an exploded view of the mask from the front; and

FIG. 4 is an exploded view of the mask from the rear.

### DETAILED DESCRIPTION OF PREFERRED EMBODIMENT

FIG. 1 shows a face mask according to the invention, having a body 10, an area 12 for a lens 21 which is located above a breathing circuit area 20 that receives breathing air from filter cartridges 14, 16 and a forwardly facing air outlet 18.

Features of the mask body 10 which are important for the intended performance of the disclosed non-limiting embodiment appear in FIG. 5. The body is configured to fit to a user's face from a region of the forehead to below the user's chin and to cover from where the forehead merges into the hairline above and behind the user's eyes down the sides of the face to the user's chin. It is molded of mineral filled polypropylene, which combines lightness with good mechanical properties such as flexural modulus, stiffness and impact strength, and resistance to alkali and UV. It may be made by injection molding or by vacuum forming. The thin sheet-like main areas are bounded by upstanding (as viewed in FIG. 5) or rearwardly facing base wall 10a, lower side walls 10b and 10c, upper side walls 10d and 10e and top wall 10f that stiffen the mask body against flexing under load. A flange 10g extends across the top of the mask at a small spacing from top wall 10f, and together they serve to stiffen the top of the mask. An inverted generally V-shaped wall 30 extends across the mask and meets the walls 10b, 10c partway along their length. The wall 30 together with the lower portions of the walls 10b, 10c and the wall 10a define the outline of a breathing circuit area 20 that surrounds the nose and mouth and provide stiffness at that area. Bosses 50, 52 through the lower side walls 10b, 10c open into the breathing circuit area, as also does a centrally located aperture 68 for an exhalation valve. An aperture 10h is provided for a lens, and apertures 10i and 10j at the upper sides of the mask receive at the ends of an upper fastening band that passes behind the user's head. Apertures (not shown are also provided for a lower fastening band.

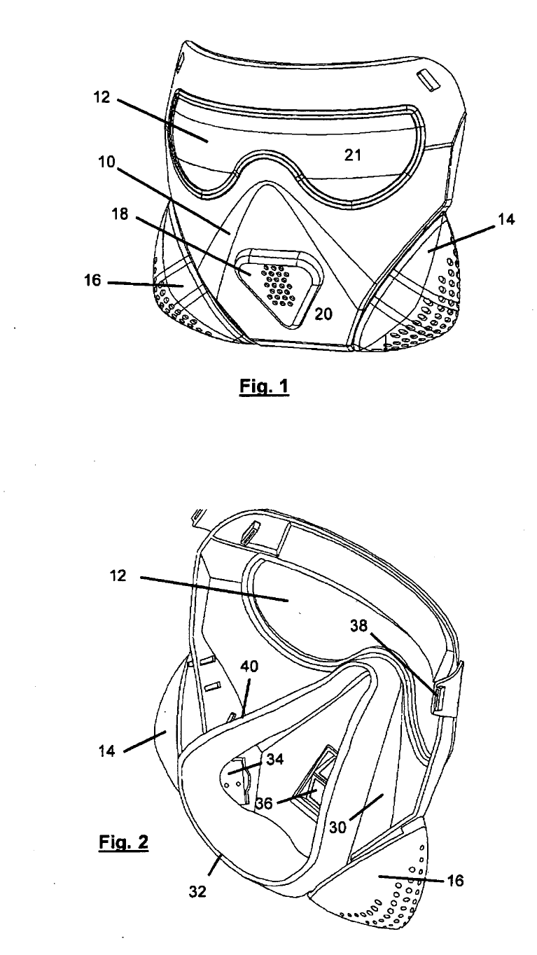

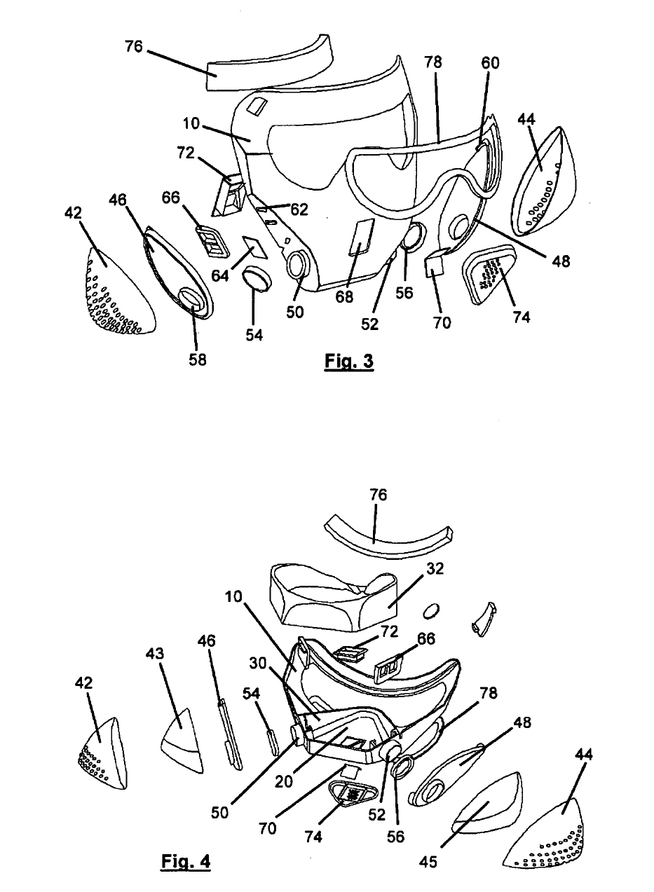

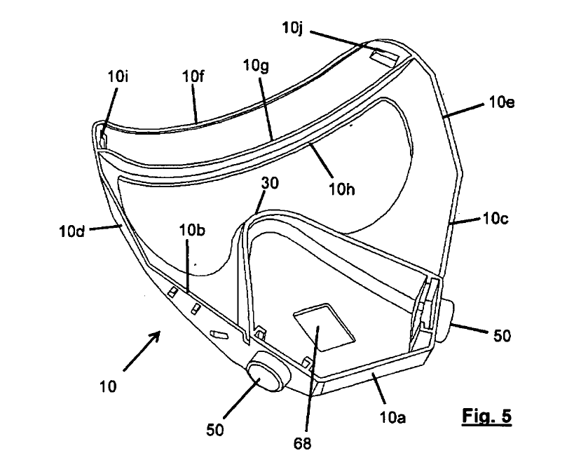

As best seen in FIGS. 2 and 4, a face seal 32 of thin silicone rubber or other elastomeric material has a groove on its forward face which fits onto the walls 30, 10a, 10b, 10c defining the breathing circuit area 20, with a chin rest and regions closely conforming to the nose. The face seal is made slightly undersized so that it is tensioned to fit onto the walls and is air-tightly retained thereon. It is apertured to either side at 34 for air inlet via bosses 50, 52 and centrally at 36 for the exhalation valve. At the top corners of the mask there can be seen attachments 38 for the upper head band. The headband supports the top of the mask on the face.

As is apparent in FIGS. 3 and 4, a forehead pad 76 fits to the top of the mask between the flanges 10f, 10 g and is held in position by Velcro® fasteners. It is covered with Coolmax® fabric developed by Du Pont to wick sweat away from the skin and to provide a barrier for inhibiting sweat from leaking onto the forehead. The lens 20 is made of polycarbonate which combines transparency and impact strength and is surrounded by an elastomeric seal or gasket 78 by which it fits into the aperture defined by wall 10h and which allows the lens 20 to be removed for replacement. The lens seal, 78 grips on to the mask and the lens 20 holding the two together. When the lens needs to be removed the user pushes it out from the inside of the mask. The lens is designed to be replaced, as during use the lens may become scratched or damaged. A one-way exhalation valve has a rear support 72 that fits into the aperture 68 and retains flap member 70 behind front cover 74. At the sides of the mask, air entry into the breathing circuit 20 is controlled by flap valves 64 held in position by retainers 66.

To either side of the mask removable intake filter units are defined by cover members 42, 44 and base members 46, 48 between which are located filter elements 43, 45, the cover members and base members being ultrasonically welded together and the filters being simple dust filters, carbon filters or a combination of both depending on the airborne contaminants with which the mask is likely to be challenged. The filters are push, bayonet or screw fits onto the spigots 50, 52, with air-tightness maintained by O-rings 54, 56, and with clips 60 (FIG. 3) snapping into slots 62 in the sidewalls 10a, 10b to hold the filters in their working positions. In an embodiment, the filters filter out particles above 5 microns such as dust, and the organic vapours such as paint fumes. These may be fixed on to the mask with a simple thread, by way of example, which only requires a 180-degree twist to lock in place. As previously explained there are location clips to tell the user that the filter is in position and also to line the filter up with the contours of the mask. The filters are changed when they become significantly contaminated as with other filters.

In use, the mask is sealed around the nose and mouth by the face seal 32, and owing to the very low working pressure of the outlet or exhalation flap valve, significant overpressure in the breathing circuit region 20 does not develop. Consequently, escape of moist exhaled air into the region beyond the face seal 32 and behind the lens 20 is minimal. Furthermore, at least the sides of the mask beyond the seal 32 are open for air circulation behind the lens 20 so that perspiration can evaporate and for these reasons the mask is relatively resistant to misting up of the lens even when the user is engaged in manual work. The air passes through inhalation valves which only open one way towards the user's mouth and nose, so the filters don't have any exhaust air going through them which would cause the filters to heat up, making for a more uncomfortable product. The air then goes out of the mask through the exhalation valve on the front of the mask. This is positioned downwards so as not to breathe on the lens or eye area and mist the lens up. The exhaust valve is also a one-way design so as not to allow the valve to open when the user is breathing in.

The mask has been designed to be durable and with all parts removable and replaceable. If a lens or seal is damaged or has worn out, a replacement part can easily be substituted. There are many parts to the mask to enable it to function fully. This also enables the user to dismantle the mask fully for general cleaning and maintenance.

1. A face mask comprising
a generally sheet-like plastics body configured to fit to the face so as to extend between the forehead and the chin and from side regions of the of the forehead down the sides of the face to either side of the chin:
a lens supported by upper portions for providing eye protection, said upper portions of the body being open to the surrounding air;
a half mask respirator located at portions of the body below the lens for fitting gas-tightly around the nose and mouth, rearwardly facing walls on a normally concealed surface of the body defining an outline of a breathing circuit area of said body forming part of said respirator; and
a face seal which is a push fit onto said walls.

2. The mask of claim 1, wherein the body is of mineral-filled plastics.

3. The mask of claim 1, further comprising a forehead pad attached to the normally concealed surface of the body above the lens.

4. The mask of claim 1, wherein rearwardly facing lower lateral walls defined by portions of said body are formed with inlets opening into the breathing circuit area, and said walls are configured to support filter cartridges removably located to opposed sides of the mask.

5. The mask of claim 1, further comprising an exhaust located approximately in the middle of the breathing circuit area.

6. The mask of claim 1, further comprising a unidirectional flap valve for controlling flow of air through the exhaust.

7. The mask of claim 1, wherein the face seal is of elastomeric material and is formed with a groove on its forward face for fitting onto the rearwardly facing walls of the body defining the outline of the breathing circuit area.

8. The mask of claim 7, wherein the elastomeric material is silicone rubber.

9. The mask of claim 7, wherein the face seal is made slightly undersized for fitting in tension onto the rearwardly facing walls.

10. A face mask comprising a half mask respirator for fitting gas-tightly around the nose and mouth and a lens supported above the respirator for providing eye protection, portions of the mask surrounding the lens above the respirator being open to the surrounding air, the mask having rearwardly facing walls defining an outline of the respirator, and a face seal being a push fit onto said walls.
